(19) United States
(12) Patent Application Publication
(10) Pub. No.: US 2020/0229912 A1
(43) Pub. Date: Jul. 23, 2020

(54) GAS INDUCTION CHAMBER FOR LARGE ANIMALS

(71) Applicant: Dezort Enterprises, LLC, Tarentum, PA (US)

(72) Inventor: Michael DeZort, Tarentum, PA (US)

(73) Assignee: Dezort Enterprises, LLC, Tarentum, PA (US)

(21) Appl. No.: 16/749,520

(22) Filed: Jan. 22, 2020

Related U.S. Application Data
(60) Provisional application No. 62/795,098, filed on Jan. 22, 2019.

(51) Int. Cl. A61D 7/04; A61G 10/02; A61D 3/00

(52) U.S. Cl. CPC A61D 7/04; A61D 3/00; A61G 10/02

(57) ABSTRACT

The present invention is drawn to a gas induction chamber that is particularly suited to being scaled to larger animals, such as swine. The present invention solves the problems associated with researchers having to physically restrain animals to inject them with sedative and/or holding a cone over the animal's face to introduce sedation. That process can be dangerous for both the researcher and the animal. The present invention provides a gas induction chamber for use with larger animals comprised of a combination of interconnecting frame members for use in connecting side panels, roof panels, and floor panels into a leak-free chamber. A gas inlet pipe is located near the top of the back side panel and an extraction pipe located near the bottom of the back side panel.

### CROSS-REFERENCE TO RELATED APPLICATION

This application claims priority to U.S. Provisional Application Ser. No. 62/795,098, filed on Jan. 22, 2019, which application is incorporated by reference herein in its entirety.

### BACKGROUND OF THE INVENTION

Currently there is no device to assist in the sedation of medium to large-sized animals. Presently, researchers conducting experiments with larger animals, such as pigs, have to physically restrain the animals, inject the animals with sedative and/or hold a cone over the animals' faces to introduce sedation. These processes can be dangerous for both the researcher and the animal.

In particular, swine are often considered the penultimate preclinical model for surgical or translational research. Swine are intelligent and respond well to positive reinforcement training. However, behavioral responses to stress include: vocalization, attempts to escape or hide, charging, or snapping. At the same time, injectable drug combinations are frequently given intramuscularly for sedation, and are considered to cause brief/momentary pain or distress.

By comparison, inhalant anesthesia can be tailored to effect, and generally is characterized by a rapid induction and recovery. The induction chamber of the present invention allows for use of inhalant anesthesia with large animals. In particular, the induction chamber of the present invention is novel and beneficial because it replaces the existing process for the sedation of medium/large lab animals with a non-invasive, gas induced procedure. The utility of the design allows for the elimination of negative and aggressive behavior in animals which follows from the traditional course of frequent, injection-based sedation. The gas induction chamber allows for the non-invasive sedation of the animals in a controlled environment, with the safe disposal of waste anesthetic gases. It also provides significant safety advantages for clinicians and staff because they no longer are required to administer sedatives by hand.

In this respect, the present invention can be used by any laboratories or individuals that use any type of animal for testing that require anesthesia or other types of gas treatments, including but not limited to veterinarians and zoos.

### BRIEF SUMMARY OF THE INVENTION

The present invention provides a gas induction chamber for use with large animals. More specifically, one embodiment of the present invention is a gas induction chamber for animals made from interconnecting frame members for use in connecting at least two side panels, at least one back side panel, at least one roof panel, at least one floor panel, and a front door into an enclosed rectangular chamber. Connectors are used to connect the framing members to each other. In one embodiment, at least one of the panels and/or at least one door is comprised of a clear material to form a window. All joints, points of intersection, door(s) and windows are sealed with at least one type of sealing mechanism to prevent the leaking of gas. A gas inlet pipe is located near the top of the back side panel and an extraction pipe located near the bottom of the back side panel.

Another embodiment of the present invention is directed to a method for anesthetizing an animal. That method comprises putting the animal into a gas induction chamber where the chamber is comprised of interconnecting frame members for use in connecting at least two side panels, at least one back side panel, at least one roof panel, at least one floor panel, and a front door into an enclosed rectangular chamber. The chamber also uses connectors to connect the framing members to each other; a gas inlet pipe located near the top of the back side panel; and an extraction pipe located near the bottom of the back side panel. All joints, points of connection, and doors are sealed to prevent the leakage of gas. The method according to this embodiment includes injecting sedative gas into the chamber through the gas inlet pipe at an amount that is appropriate for the size of the animal, waiting for the animal to become anesthetized; removing the remaining sedative gas from the chamber through the extraction pipe; and removing the animal from the chamber through the front door.

### BRIEF DESCRIPTION OF THE SEVERAL VIEWS OF THE DRAWINGS

For the purpose of facilitating understanding of the invention, the accompanying drawings and description illustrate preferred embodiments thereof, from which the invention, various embodiments of its structures, construction and method of operation, and many advantages, may be understood and appreciated.

FIG. 1 is a front perspective view of one embodiment of an induction chamber of the present invention;

FIG. 2 is a front view of one embodiment of an induction chamber of the present invention;

FIG. 3 is a top view of one embodiment of an induction chamber of the present invention;

FIG. 4 is a side view of one embodiment of an induction chamber of the present invention;

FIG. 5 is a top front perspective view of one embodiment of an induction chamber of the present invention;

FIG. 6 is a top back perspective view of one embodiment of an induction chamber of the present invention;

FIGS. 7A and 7B are top front perspective views of an alternative embodiment of an induction chamber of the present invention having front and side hinged doors that are open (7B) and closed (7A); and

FIG. 8 is a top back perspective view of one embodiment of the present invention with hinged front and side doors.

### DETAILED DESCRIPTION OF THE INVENTION

The present invention will be understood more readily by reference to the following detailed description of the invention and the accompanying figures, which form a part of this disclosure. This invention is not limited to the specific devices, methods, processes, elements or parameters described and/or shown herein and the terminology used herein is for the purpose of describing particular embodiments and is by way of example only and not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

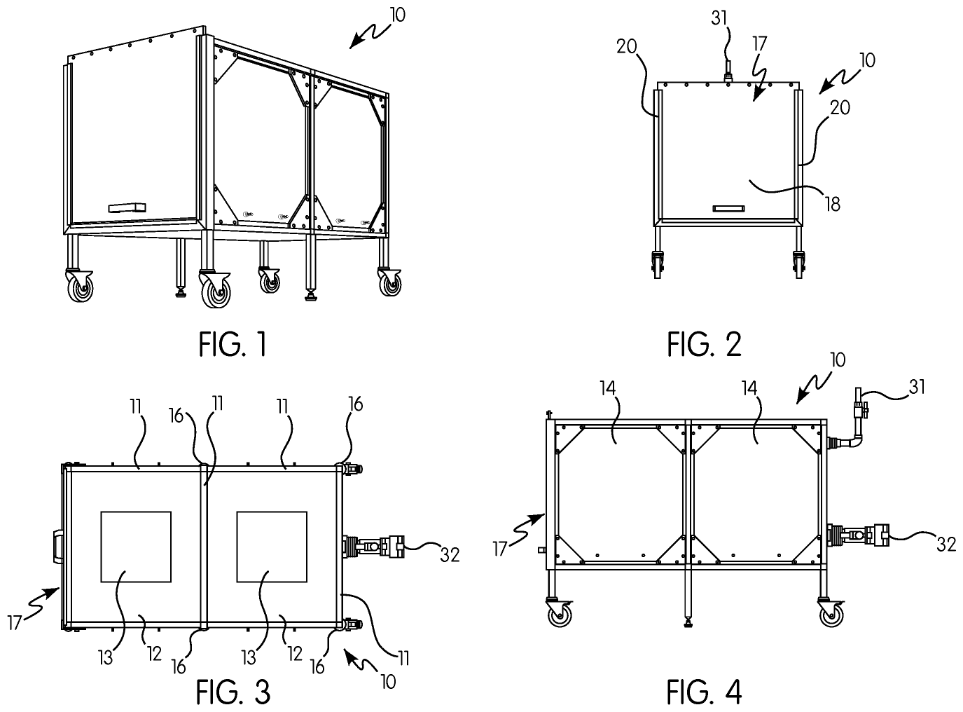

Referring to FIGS. 1 through 8, the present invention provides a gas induction chamber 10 for use with large animals. In one embodiment, shown in FIG. 1, the chamber 10 of the present invention includes interconnecting framing members 11 for use in holding roof panels 12, side panels 14 and back side panel(s), optional view window(s) 13 and floor panels 15 to define a chamber 10 with an internal hollow space. For most embodiments of the present invention the preferred shape of the chamber 10 will be a rectangle, but any desired shape can be constructed and stay within the bounds of the present invention. In a preferred embodiment, the framing members 11 include connectors 16 that allow for variable connection of framing members 11 in order to allow for modular expansion of the height, length and/or width of chamber 10. For example, FIGS. 1 through 6 show the use of two side panels 14 per side, but three or more side panels 14 can be used to expand the length of chamber 10 or one side panel 14 can be used to shorten the length of the chamber 10. In one embodiment of the present invention, the framing members 11 are comprised of hollow aluminum tubes with T-slots (also known as T-slot aluminum), which provides a durable light-weight frame that allows for ease of assembly (the panels 12, 14, 15 and 30 fit within the T-slots). Other materials providing similar properties and modular attachments and expansions also can be used and all such substitutions are included within the scope of the present invention. In one embodiment, the connectors 16 preferably are comprised of aluminum and connect to the ends of the framing members 11, but any connectors 16 that are compatible with T-slot aluminum or the primary construction material of the chamber 10 can be used. In a preferred embodiment of the present invention, windows 13 are comprised of a durable clear polycarbonate to allow for viewing inside the chamber 10. Other clear materials can also be used for windows 13. Windows 13 may be a part of a side panel 14, 30, a roof panel 12 and/or a door 18, 22 (as shown in FIGS. 3, 5 and 6) or an entire side panel 14, 30, a roof panel 12 and/or a door 18, 22 may be constructed out of a transparent material to act as a window 13. Alternative embodiments of the present invention many not have any windows 13 or may have any number of windows 13. Once assembled, the joints and connection points at and between the roof panels 12, view windows 13, side panels 14, back side panels 30 and floor panels 15 are all sealed using at least one type of sealing mechanism—preferably, in one embodiment, the sealing mechanism is high bond foam tape. In another embodiment, the joints are sealed with “F” curve EPDM rubber seals, as an alternative sealing mechanism. In yet another embodiment of the present invention, each opening at the roof panels 12, view windows 13, side panels 14, back side panels 30 floor panels 15, front door 18 and optional side door 22 will be gasketed (a third type of sealing mechanism). It will be obvious to one skilled in the art that gussets and fasteners can be used to connect any or all of the parts of the present invention as necessary to create a secure and stable chamber 10. The gussets and fasteners can be made of any appropriate materials including but not limited to UHMW self-sealing fasteners and aluminum. All such sealing mechanisms and any other types known in the art that will seal the door(s) 17, 22, window(s) 13, roof panel(s) 12, framing members 11, side panels 14, 30 floor panel(s) 15, etc. are included within the scope of the present invention.

In one embodiment of chamber 10, roof panels 12, side panels 14, 30 and floor panels 15 are comprised of ultra-high-molecular-weight polyethylene (“UHMW”) or other similar polymer material. It is beneficial that the material composition of the panels allows for ease of cleaning during a wash-down procedure of chamber 10. In another embodiment of the present invention the chamber 10, roof panels 12, side panels 14, 30 and floor panels 15 are comprised of stainless steel.

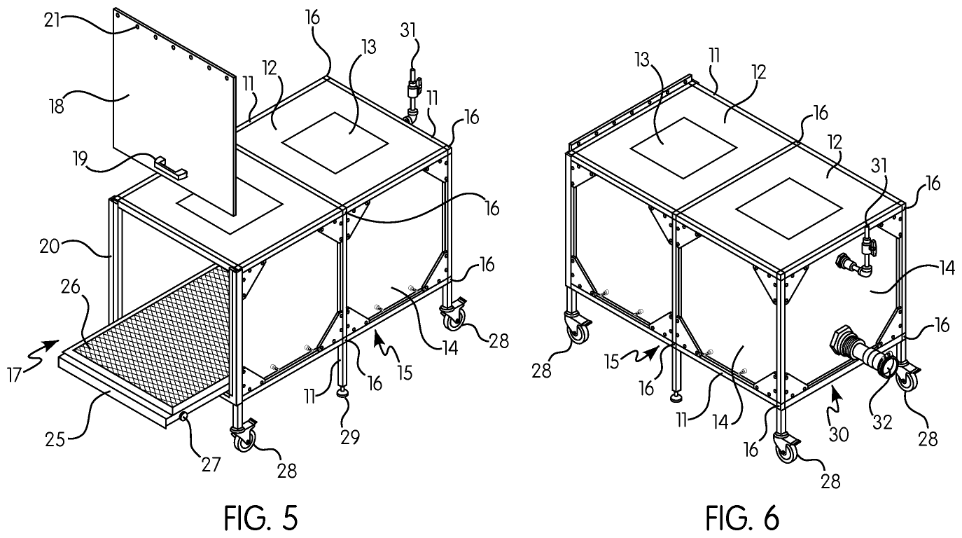

In one embodiment of the present invention shown in FIG. 5, the front 17 of chamber 10 has a sliding front door 18 with handle 19 (shown in FIG. 2) and a fire stop door sweep 21 at the top of the sliding front door 18. Sliding front door 18 slides within door channels 20, which are mounted to or are an integral part of framing members 11 (shown in FIG. 2). Preferably the door channel(s) 20 includes a gasket to aid in sealing chamber 10 while in use. The door channel(s) 20, in one embodiment, also is comprised of aluminum, and sliding front door 18 is clear for viewing purposes and is comprised of a durable clear polycarbonate or other similar material. In another embodiment of the present invention, the sliding front door 18 may be comprised of the same material as the roof panels 12, side panels 14, back side panels 30 and floor panels 15. A handle 19 can be comprised of plastic or other similar durable material.

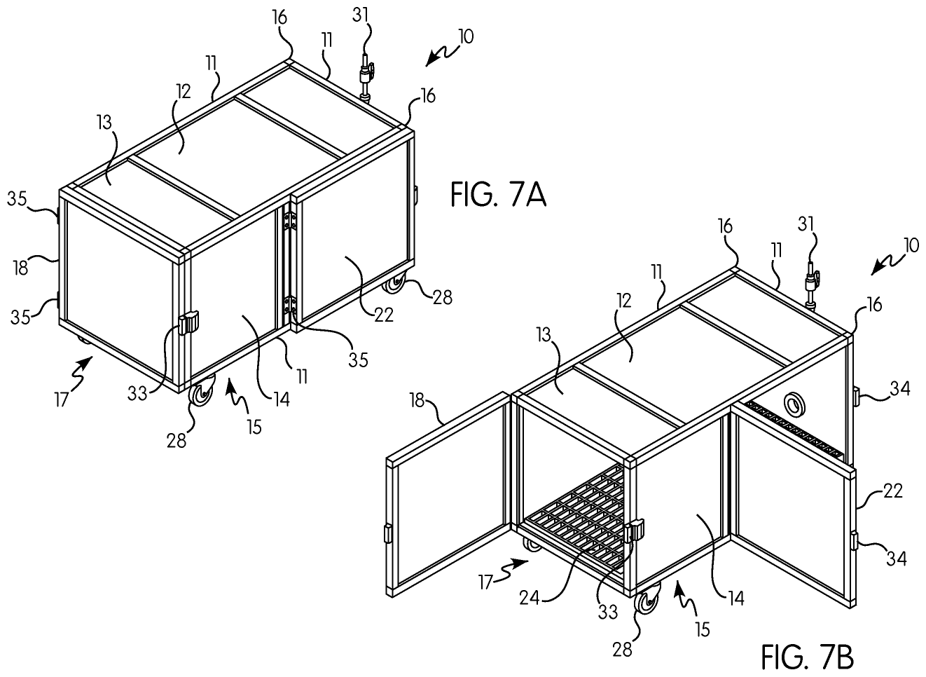

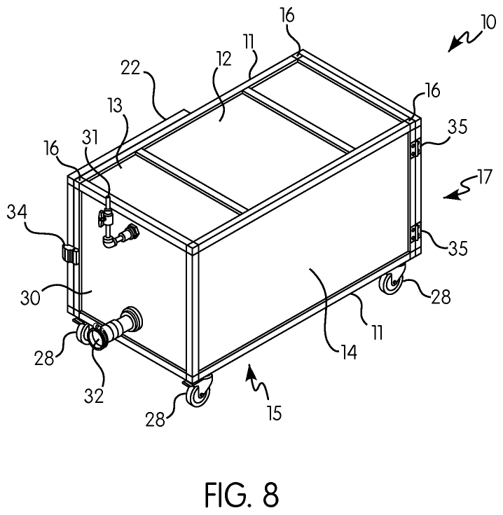

In an alternative embodiment of the present invention shown in FIGS. 7 and 8, the front door 18 may be attached to the front 17 using one or more hinges 34. In such an embodiment, the front door 18 would seal tightly against the framing members 11 using seal(s), a door sweep, flange(s), gasket(s) and/or other similar technology to serve as a sealing mechanism. The hinged front door 18 of this embodiment may use a handle 19, a front door push latch 33, a slam latch or any other appropriate closing mechanism to open and close the front door 18. In any embodiments of the present invention that utilizes a gasket around the front door 18 and/or side door 22, the doors should close tightly enough to compress the gasket(s) and seal the doors. While FIGS. 7 and 8 show the front door 18 with hinges 34 at the side, in some embodiments it may be preferable to have the hinges 34 located at the top or the bottom of the front door 18.

In one alternative embodiment of the present invention shown in FIGS. 7 and 8, the chamber 10 has at least one side door 22. The side door 22 may be attached using hinges 34 as shown in FIGS. 7A and 7B or it may be constructed as a sliding side door 22 according to the description provided for a sliding front door 18. In any embodiment, the side door 22 may have a handle 19. In an embodiment using a hinged side door 22, the side door 22 may use a handle 19, a slam latch, a side door push latch 34 or any other appropriate closing mechanism to open and close the side door 22. In any embodiment, the side door 22 would seal tightly against the framing members 11 using a seal, door sweep, flange, gasket and/or other similar technology. The side door 22 may be clear for viewing purposes and may be comprised of a durable clear polycarbonate or other similar material. In another embodiment of the present invention, the side door 22 may be comprised of the same material as the roof panels 12, side panels 14, back side panels 30 and floor panels 15. The optional handle 19 can be comprised of plastic or other similar durable material. While FIGS. 7 and 8 show the side door 22 with hinges 34 at the side, in some embodiments it may be preferable to have the hinges 34 located at the top or the bottom of the side door 22.

If the side door 22 is constructed as a sliding side door 22 then it would also have a fire stop door sweep 21 at the top of the side door 22 or any other acceptable mechanism to accomplish the same purpose. Sliding side door 22 slides within at least one door channel 20, which is mounted to or designed as a part of the framing members 11. Preferably any door channel 20 includes a gasket to aid in sealing chamber 10 while in use or any other acceptable mechanism to accomplish the same purpose. The side door 22 may be comprised of the same material as the roof panels 12 and side panels 14 or it may be constructed to contain or to be a window 13.

Referring to FIG. 5, the front 17 of chamber 10 opens, when the sliding front door 18 is lifted, to reveal the inside of chamber 10. In one embodiment of the present invention, the sliding front door 18 is held in place by two pressure rated rubber coated pins, which could apply approximately 10 psi of pressure. It will be obvious to one skilled in the art that the sliding front door 18 can be constructed with a variety of catch mechanisms or no catch mechanism.

In one embodiment of the present invention, a slidable pull-out tray 25 is mounted above the floor of chamber 10, and this tray 25 is used to support the body of a large animal when chamber 10 is in use. In one preferred embodiment, the slidable pull-out tray 25 includes easy wash panelized rubber matting 26 and is comprised of an aluminum heavy duty grating. It will be obvious to one skilled in the art that the tray 25 can be made out of any material (or combination of materials) that is easy to clean, supports the animal, and can be constructed to slide or to be removed. Additionally, it will be obvious to one skilled in the art that there are a number of effective ways to mount a tray 25 on and above the floor of the chamber 10 so that it can slide in and out. In one embodiment of the present invention, the slidable tray 25 can slide on rails mounted inside of chamber 10, with slidable tray 25 having two or more rollers 27 mounted on each side of slidable tray 25 (as shown in FIG. 5).

The slidable tray 25 provides multiple benefits to a user of the present invention. First, the tray 25 allows for easier movement of a large animal into and out of chamber 10. In particular, after an animal is sedated, it is easier to remove the animal from the chamber 10 and off of the tray 25 when the tray 25 is slid out of chamber 10. Second, this process avoids having a user lean into the chamber 10 when any residue of the gas-based sedative remains inside chamber 10. In a preferred embodiment of the present invention, the tray 25 preferably has a load rating of 600 lbs. In an alternative embodiment that utilizes a side door 18, the slidable pull-out tray 25 may be eliminated where access to the animal is sufficient through the use of the front door 18 and the side door 22.

Any embodiments of the present invention may include the use of a removable grating 24 (as shown in FIG. 7B), which facilitates the cleaning of the chamber 10, especially in those embodiments that do not utilize a slidable pull-out tray 25. In the preferred embodiment, the removable grating 24 is comprised of fiberglass. Similarly, removable floor plugs and drains may be added to any embodiment of the present invention to aid in the cleaning and drainage of the chamber 10. Such plugs and drains are particularly useful in embodiments of the present invention that do not utilize a slidable pull-out tray 25.

Referring to FIGS. 5 and 6, in one embodiment of the present invention, the chamber 10 is preferably attached to rollable casters 28 positioned, at a minimum, at the corners of chamber 10. In one embodiment of the present invention, the casters 28 attach to the framing members 11. Additional casters 28 can be located along the sides of chamber 10. Optionally, a mid-leveling foot 29 can be located at a midpoint between adjacent casters 28. In one preferred embodiment, casters 28 are friction fit aluminum framing casters, and foot 29 is also comprised of friction fit aluminum.

Referring to FIGS. 4, 6 and 8, the back side panel 30 of chamber 10 has a gas inlet pipe 31 located near the top of the back side panel 30 and an extraction pipe 32 located near the bottom of panel 30. Gas inlet pipe 31 is used to provide sedative gas to the inside of chamber 10, and extraction pipe 32 is used as an exhaust mechanism to remove the sedative gas. The sedative gas is typically heavier than air and will collect toward the bottom of chamber 10. In one preferred embodiment, gas inlet pipe 31 is comprised of PVC and includes a stop cock valve and slip fitting. This type of gas inlet pipe 31 is standard and known to those with skill in the art. Also, in one preferred embodiment, extraction pipe 32 is comprised of black PVC and includes a Fernco® fitting. This fitting is also standard and known to those with skill in the art. The materials for both pipe 31 and pipe 32 can vary.

The dimensions of chamber 10 can vary depending on the size of the animal being treated. However, in the preferred embodiment of the present invention the height, width and depth of the chamber 10 should be kept as small as possible to decrease the load on the framing members 11, the floor panels 15 and the casters 28, which then increases the weight capacity of the chamber 10. In one embodiment used with pigs or swine, all panels are cut from ⅜″ thick high impact rated UHMW plastic sheets, and view windows 13 are cut from 3/16″ thick clear polycarbonate. The viewing door is cut from ⅜″ thick clear polycarbonate. Side panels 14 are about 23.5″ wide and about 26″ high. Back side panel 30 and front door 18 are about 27″ wide.

This one embodiment of the induction chamber 10 of the present invention was tested with swine and was well tolerated in 3 different groups, totaling 40 individual pigs, and 20+anesthesia events. In particular, the recovery following chamber induction showed reduced vomiting, and improved the time to extubation and return to normal activity, as follows:

| Parameter | IM Sedation (KX) | | Chamber Induction | |
|---|---|---|---|---|
| HR following induction | 110 | bpm | 150 | bpm |
| Time to intubation | 30 | minutes | 40 | minutes |
| Time to extubate | 10 | minutes | 5 | minutes |
| Time to eating | 30 | minutes | 15 | minutes |
| Total Time: | 70 | minutes | 60 | minutes |

These results greatly improve the welfare of long-term resident swine, which is in accordance with regulatory agencies for testing facilities (USDA, OLAW, and AAALAC).

These tests also demonstrated that an increase in drug cost for anesthesia was off-set by a decrease in technical time charged to the investigator. As such, the induction chamber 10 is a cost-effective refinement strategy for repeat sedation in miniature swine.

As noted above, the induction chamber 10 of the present invention also addresses safety issues by minimizing exposure to the sedative gas. In this context, the Occupational Safety and Health Administration (OSHA) has no permissible exposure limits regulating halogenated agents. The National Institute of Occupational Safety and Health (NIOSH), however, has recommended that no person exceed 2 ppm exposure in 1 hour.

By comparison, WAG (waste air gas) exposure in the induction chamber 10 of the present invention has remained below NIOSH recommended limit. In particular, average exposure has remained ≤1 ppm.

In addition, testing confirmed that induction chamber 10 eliminated occupational health and safety risks associated with manual restraint for injection.

What is claimed is:

1. A gas induction chamber for animals, comprising:
a plurality of interconnecting frame members for use in connecting at least two side panels, at least one back side panel, at least one roof panel, at least one floor panel and a front door into an enclosed rectangular chamber;
a plurality of connectors to connect the framing members to each other;
a gas inlet pipe located near the top of the back side panel; and
an extraction pipe located near the bottom of the back side panel, wherein the joints and points of intersection of the at least two side panels, at least one back side panel, at least one roof panel, at least one floor panel, front door, gas inlet and extraction pipe are sealed.

2. A gas induction chamber according to claim 1, further comprising a sealed window to view the interior of the chamber.

3. A gas induction chamber according to claim 1, wherein the front door is a sliding front door with a handle and a door sweep at the top of the sliding front door, and wherein the front door slides within door channels on the front frame members.

4. A gas induction chamber according to claim 1 including a slidable pull-out tray mounted above the at least one floor panel.

5. The gas induction chamber according to claim 4, wherein the slidable pull-out tray supports body of the animal.

6. A gas induction chamber according to claim 1 wherein the front door is a hinged front door with the hinges mounted on the front frame members.

7. A gas induction chamber according to claim 6, also comprising a push lock mechanism attached to both the front door and one of the front frame members to open and close the door.

8. A gas induction chamber according to claim 1 also comprising a side door located along one side of the chamber.

9. A gas induction chamber according to claim 1 or 4 including a removable grating that sits above the at least one floor panel.

10. A method for anesthetizing an animal, comprising:
putting the animal into a gas induction chamber wherein the chamber is comprised of interconnecting frame members for use in connecting at least two side panels, at least one back side panel, at least one roof panel, at least one floor panel, and a front door into an enclosed rectangular chamber; connectors to connect the framing members to each other; a gas inlet pipe located near the top of the back side panel; and an extraction pipe located near the bottom of the back side panel, wherein the joints and points of intersection of the at least two side panels, at least one back side panel, at least one roof panel, at least one floor panel, front door, gas inlet and extraction pipe are sealed;
injecting sedative gas into the chamber through the gas inlet pipe at an amount that is appropriate for the size of the animal;
waiting for the animal to become anesthetized;
removing the remaining sedative gas from the chamber through the extraction pipe; and
removing the animal from the chamber through the front door.

11. A method for anesthetizing an animal according to claim 10, wherein the chamber has at least one side door located along one side of the chamber to facilitate maneuvering the animal into and out of the chamber.

12. A method for anesthetizing an animal according to claim 11, wherein the chamber also has a slidable pull-out tray mounted above the at least one floor panel.

13. A method for anesthetizing an animal according to claim 10 or 12 also comprising a removable grating that sits above the floor panels.

14. A method for anesthetizing an animal according to claim 10, wherein the chamber also has a window to enable the viewing of the animal while inside of the chamber.
